(19) United States
(12) Patent Application Publication
(10) Pub. No.: US 2013/0269329 A1
(43) Pub. Date: Oct. 17, 2013

(54) HYDRAULIC PRESSURE SYSTEM FOR A HYDRAULIC VEHICLE

(71) Applicant: CATERPILLAR GLOBAL MINING LLC, Oak Creek, WI (US)

(72) Inventor: Mark P. Vonderwell, Franklin, WI (US)

(73) Assignee: Caterpillar Global Mining LLC, Oak Creek, WI (US)

(21) Appl. No.: 13/721,443

(22) Filed: Dec. 20, 2012

Related U.S. Application Data
(60) Provisional application No. 61/625,242, filed on Apr. 17, 2012.

(51) Int. Cl. F15B 15/18

(52) U.S. Cl. CPC F15B 15/18
USPC 60/327; 60/459

(57) ABSTRACT

A hydraulic system includes one or more hydraulic pumps, one or more hydraulic motors, a hydraulic tank, and fluid lines. The hydraulic system also includes one or more check valves fluidly connected to the hydraulic pumps and the hydraulic motors. The hydraulic system also includes one or more pilot-operated valves, operably coupled to the check valves by one or more pilot lines. The pilot-operated valves are configured to receive fluid pressure from the fluid lines, opening to allow hydraulic fluid to travel between fluid lines.

### CROSS-REFERENCE TO RELATED APPLICATIONS

This application claims the benefit of priority to U.S. Provisional Patent Application No. 61/625,242, which was filed on Apr. 17, 2012, the complete disclosure of which is incorporated by reference herein.

### TECHNICAL FIELD

This disclosure relates to hydraulic systems for hydraulically driven vehicles, and more particularly to a hydraulic system having pilot-operated makeup check valves for maintaining a desired pressure balance across one or more hydraulic motors in a hydraulic vehicle.

### Background

Hydraulic vehicles are powered by hydraulic pressure systems. In these systems, hydraulic fluid is often transmitted from one or more hydraulic pumps to one or more hydraulic motors (and/or hydraulic cylinders) throughout the vehicle, powering the vehicle's working implements (e.g. shovels, tracks, etc.) as necessary. The hydraulic fluid is then cycled back through a hydraulic tank and to the hydraulic pumps, forming a hydraulic circuit. If the supply fluid flow to the motor inlet is less than the flow of fluid drawn into the motor, however, the motor inlet may be “starved” (e.g. causing cavitation or voiding at the motor inlet), potentially damaging the hydraulic system. To protect against this condition, conventional hydraulic systems often include a back pressure check valve to apply back pressure to the return line. If the fluid pressure to the motor inlet drops below the back pressure, then a makeup check valve opens to allow return hydraulic fluid to pass to the motor inlet, so that the motor inlet is not voided.

Mining vehicles, such as hydraulically driven mining shovels, typically have an upper portion or carriage rotatably mounted to a lower portion or carriage. The upper carriage typically includes power generation equipment and power-operated tools, an operator cab, controls, and often a hydraulic storage tank for containing the hydraulic fluid used by the vehicle. The lower carriage typically includes the tracks and the motors for driving the tracks. In order to drive the tracks in these types of mining vehicles, hydraulic pumps must send hydraulic fluid from the upper carriage down to the lower carriage, and into the track motors. In a conventional mining shovel with a rotating upper carriage, the hydraulic pumps may send hydraulic fluid to a rotor, or swivel, which acts as a conduit between the upper and lower carriage. The rotor receives hydraulic fluid from the hydraulic pumps, and sends the hydraulic fluid to the track motors located within the lower carriage. The motors then send the hydraulic fluid back through the rotor in order to return to the pumps.

In these types of mining vehicles, use of a back pressure check valve may not be an effective method to prevent voiding at the motor inlet. The hydraulic fluid path from the pumps to the motors can be long in large mining vehicles, and there is often significant pressure loss as the hydraulic fluid travels through the length of the flow path to the motors. In addition, the rotor typically includes restrictive hydraulic fluid passages, which may cause a further pressure drop. As a result, the back pressure required to provide an adequate hydraulic fluid supply to the motors can be as high as 50 bar in some instances. Providing a back pressure of this level tends to reduce the efficiency of the hydraulic circuit, and the maximum torque available to the motors. As a result, the productivity of the vehicle is reduced. Therefore, the conventional method to prevent voiding the motor inlet may not be feasible in these types of mining vehicles.

### SUMMARY

An embodiment of the present disclosure relates to a hydraulic system for a hydraulic vehicle. The hydraulic system includes one or more hydraulic pumps configured to pump pressurized fluid through the hydraulic system, one or more hydraulic motors configured to receive pressurized fluid, and to power one or more working implements, a hydraulic tank configured to receive return fluid flow from the hydraulic motors and supply the fluid to the hydraulic pumps, and one or more fluid lines configured to transfer fluid throughout the hydraulic system. The hydraulic system also includes one or more check valves fluidly connected to the hydraulic pumps and fluidly connected to the hydraulic motors, the check valves configured to receive fluid from the hydraulic pumps at a first end, and to supply fluid to the hydraulic motors at a second end, and configured to move from a closed position to an open position when the fluid pressure at the first and second ends reaches a first predetermined pressure differential, allowing fluid to travel from the hydraulic pumps to the hydraulic motors.

In this embodiment, the hydraulic system also includes one or more pilot-operated valves, operably coupled to the check valves by one or more pilot lines, and configured to move from a first position to a second position when the fluid pressure at the check valves reaches the first predetermined pressure differential, the second position fluidly connecting the pilot-operated valves to the fluid lines. The pilot-operated valves are configured to receive fluid pressure from a first fluid line and a second fluid line, opening and allowing fluid to travel in a single direction between the first and second fluid lines when the pressure in the first and second fluid lines reaches a second predetermined pressure differential.

Another embodiment of the present disclosure relates to a hydraulic vehicle. The hydraulic vehicle includes one or more fluid lines configured to transfer fluid throughout the vehicle, and an upper carriage configured to rotate independently of a lower carriage. The upper carriage includes one or more hydraulic pumps configured to pump pressurized fluid to the fluid lines, and a hydraulic tank configured to receive return fluid flow from one or more hydraulic motors and supply the fluid to the hydraulic pumps.

In this embodiment, the hydraulic vehicle also includes a lower carriage. The lower carriage includes one or more hydraulic motors configured to receive pressurized fluid, and to power one or more working implements. The lower carriage also includes one or more check valves fluidly connected to the hydraulic pumps and fluidly connected to the hydraulic motors, the check valves configured to receive fluid from the hydraulic pumps at a first end, and to supply fluid to the hydraulic motors at a second end, and configured to move from a closed position to an open position when the fluid pressure at the first and second ends reaches a first predetermined pressure differential, allowing fluid to travel from the hydraulic pumps to the hydraulic motors, and one or more pilot-operated valves, operably coupled to the check valves by one or more pilot lines, and configured to move from a first position to a second position when the fluid pressure at the check valves reaches the first predetermined pressure differential, the second position fluidly connecting the pilot-operated valves to the fluid lines.

Further in this embodiment, the hydraulic vehicle includes a rotor connected on a first end to the upper carriage, and connected on a second end to the lower carriage. The pilot-operated valves are configured to detect the fluid pressure in a first fluid line and a second fluid line, opening and allowing fluid to travel in a single direction between the first and second fluid lines when the pressure in the first and second fluid lines reaches a second predetermined pressure differential.

Another embodiment of the present disclosure relates to a method for powering a hydraulic vehicle. The method includes supplying one or more hydraulic motors with fluid from one or more hydraulic pumps, returning the fluid from the hydraulic motors to the hydraulic pumps, and transmitting the fluid pressure within the system to one or more pilot-operated check valves. The method also includes providing one or more check valves moving from a closed position to an open position when the fluid pressure reaches a first predetermined pressure differential, allowing fluid to travel from the hydraulic pumps to the hydraulic motors, providing one or more pilot-operated valves moving from a first position to a second position when the fluid pressure at the check valves reaches the first predetermined pressure differential, the second position fluidly connecting the pilot-operated valves to the fluid lines, and preventing the hydraulic motors from voiding by supplying fluid in a single direction between the first and second fluid lines when the pressure in the first and second fluid lines reaches a second predetermined pressure differential.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a hydraulic mining shovel, according to an exemplary embodiment.

FIG. 2 is a schematic representation of a hydraulic system for a hydraulic mining vehicle when the hydraulic mining vehicle is in the neutral position, according to an exemplary embodiment.

FIG. 3 is a schematic representation of the hydraulic system of FIG. 2 when the hydraulic mining vehicle is moving forward.

FIG. 4 is a schematic representation of the hydraulic system of FIG. 2 when the hydraulic mining vehicle is moving forward and braking

FIG. 5 is a schematic representation of the hydraulic system of FIG. 2 when the hydraulic mining vehicle is moving in reverse.

FIG. 6 is a schematic representation of the hydraulic system of FIG. 2 when the hydraulic mining vehicle is moving in reverse and braking

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

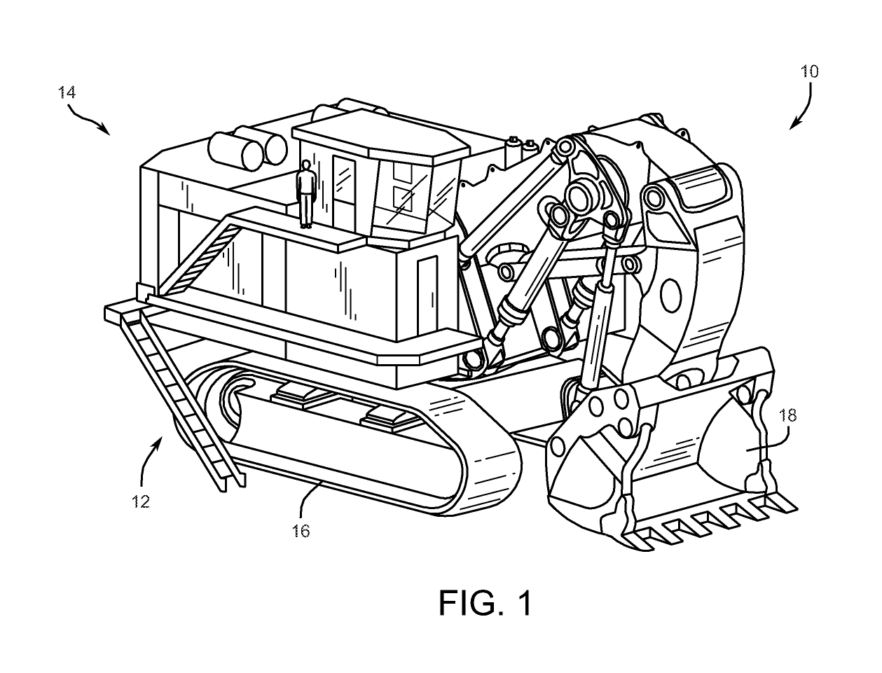

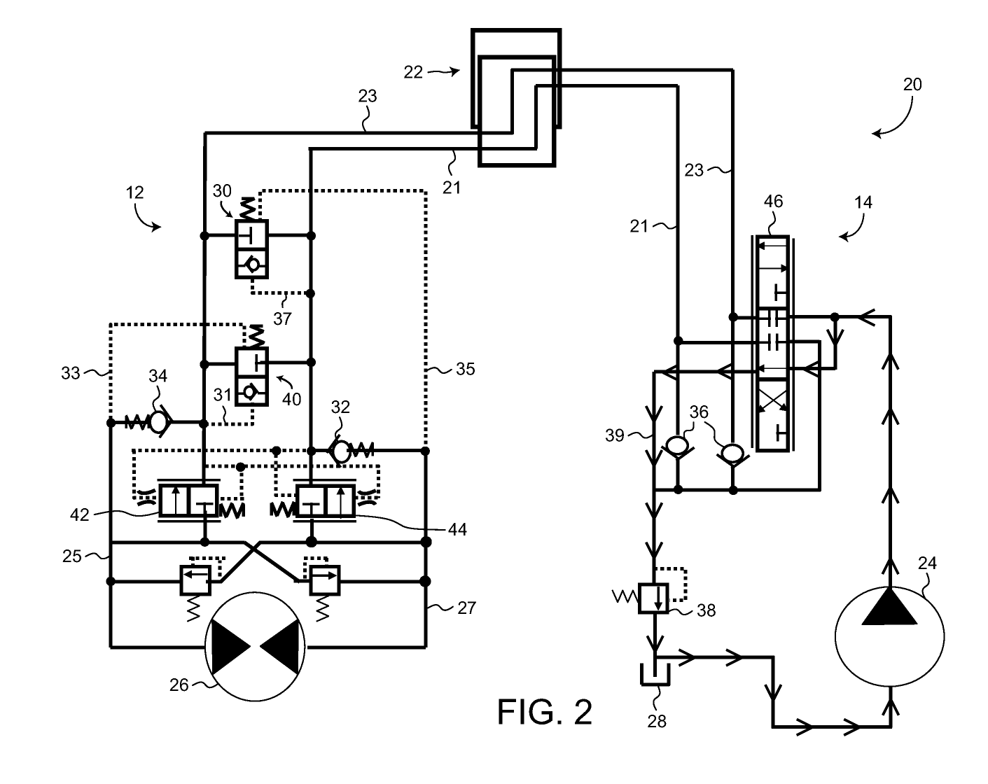

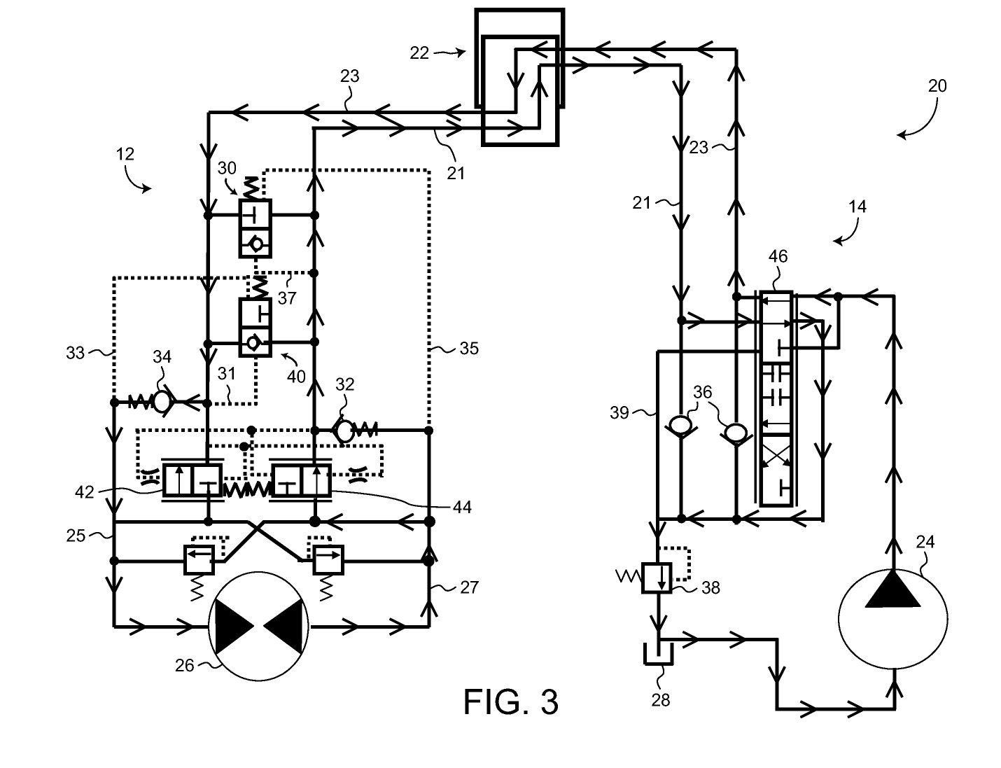

Referring to FIG. 1, a hydraulic mining vehicle 10 is shown, according to an exemplary embodiment. The hydraulic mining vehicle 10 includes an upper carriage 14 and a lower carriage 12. In exemplary embodiments, the upper carriage 14 is able to rotate about a center axis located on a rotor 22 (shown in FIGS. 2 and 3), or otherwise swivel independent of the lower carriage 12. The upper carriage 14 includes a shovel 18. The upper carriage 14 is configured to rotate, so that the shovel 18 is able to reach a larger surface area while the lower carriage 12 remains stationary for positioning the vehicle 10. The mining vehicle 10 travels by rotating tracks 16, which are driven by hydraulic motors 26 that are operated by a hydraulic system 20 located within the vehicle 10. According to the illustrated embodiment of FIG. 1, the mining vehicle 10 includes two tracks 16 that are independently controlled. In other embodiments, the vehicle 10 may include more or less tracks 16 in order to suit the application. Although the disclosure is shown and described by way of example with reference to a mining vehicle, the disclosure is also applicable for use with any vehicle that includes one or more hydraulically driven implements, and all such vehicles are intended to be within the scope of this disclosure.

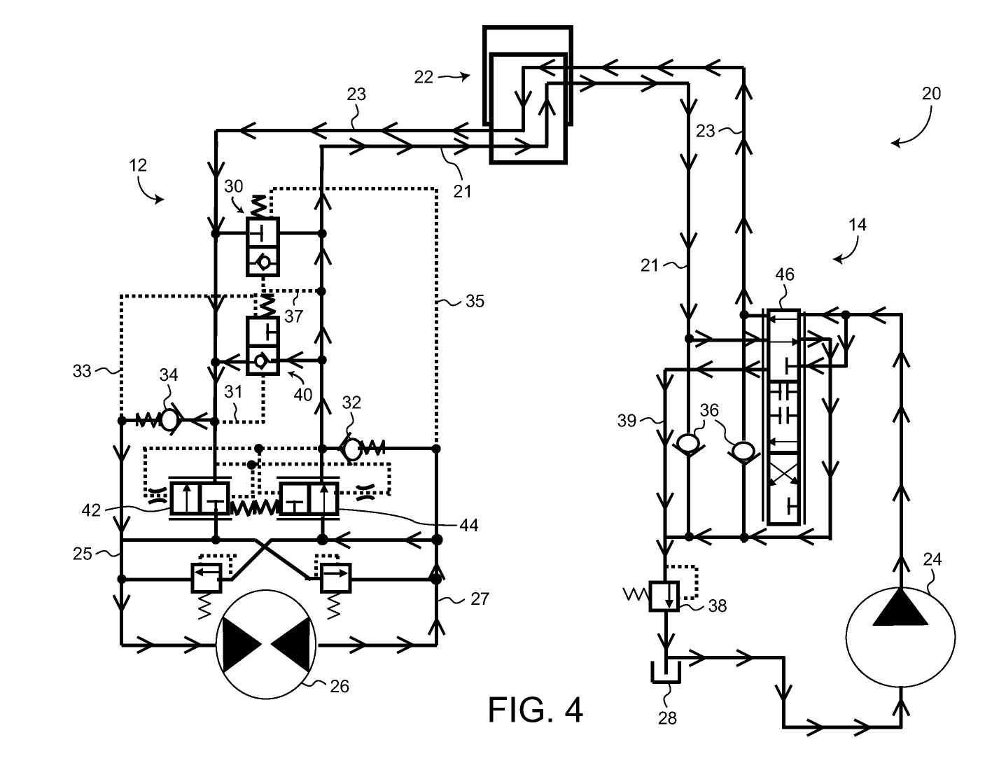

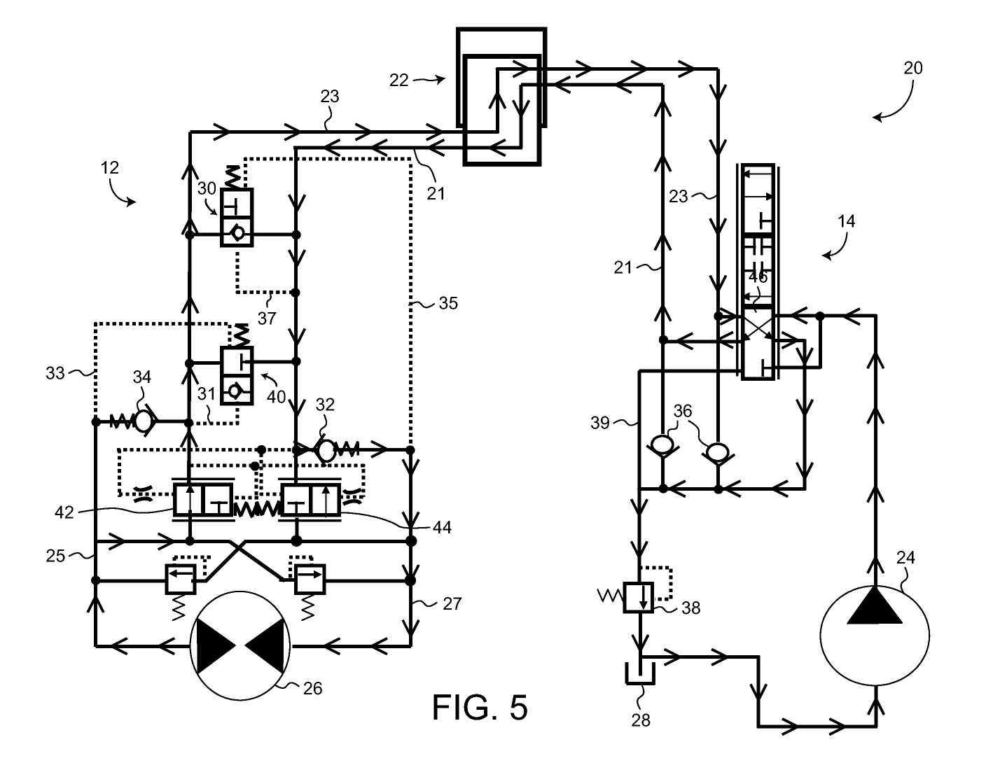

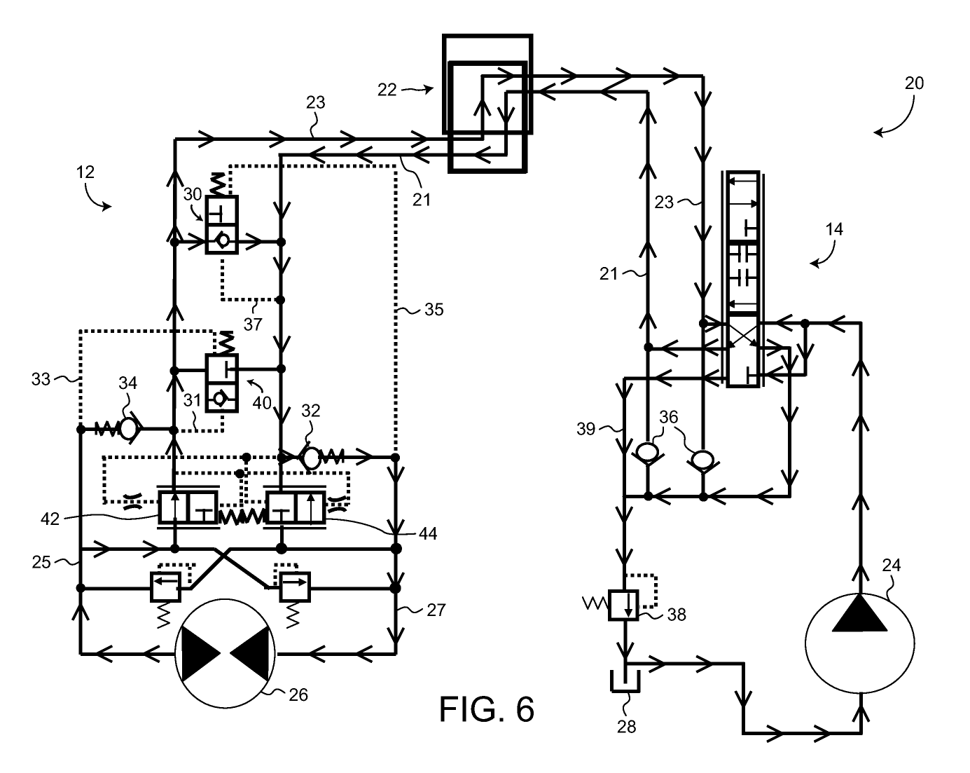

Referring now to FIGS. 2 through 6, schematic representations of a hydraulic system 20 for a single track 16 of a hydraulic mining vehicle 10 are shown, according to an exemplary embodiment. The hydraulic system 20 of the present disclosure is shown as part of a tracked mining vehicle 10, but may be used in any vehicle with one or more hydraulically driven implements. FIGS. 2 through 6 represent five different hydraulic fluid flow patterns associated with five states of the rotating track 16. FIG. 2 is a schematic representation of the hydraulic system 20 when the mining vehicle 10 and track 16 are in the neutral position. FIG. 3 is a schematic representation of the hydraulic system 20 when the track 16 is moving forward. FIG. 4 is a schematic representation of the hydraulic system 20 when the track 16 is moving forward and braking FIG. 5 is a schematic representation of the hydraulic system 20 when the track 16 is moving in reverse. FIG. 6 is a schematic representation of the hydraulic system 20 when the track 16 is moving in reverse and braking.

The hydraulic system 20 includes one or more hydraulic pumps 24, which pump pressurized hydraulic fluid through the system 20. The hydraulic pumps 24 are located within the upper carriage 14 of the mining vehicle 10. The pumps 24 are configured to pump pressurized hydraulic fluid to a control spool 46 (e.g. valve). The control spool 46 is configured to receive hydraulic fluid from the pumps 24, sending the fluid to fluid line 23 or 21. In exemplary embodiments, the system 20 has at least two modes. In a first mode, the control spool 46 sends pressurized fluid to fluid line 23. In a second mode, the control spool 46 sends pressurized fluid to fluid line 21. However, in other exemplary embodiments, the system 20 may have a single mode and a single fluid flow direction.

The pumps 24 send pressurized hydraulic fluid through the system 20 to one or more hydraulic motors 26. The motors 26 are located within the lower carriage 12 of the mining vehicle 10. The motors 26 are configured to convert a pressure differential of the hydraulic fluid (difference in fluid pressure at either side of the motors 26) into torque applied to one or more working implements (e.g. shovels, tracks, etc.). In the illustrated embodiment of FIGS. 2 through 6, torque is applied by the motors 26 to a single track 16. The pressure differential of the hydraulic fluid on either side of the motors 26 (described in further detail below) corresponds to the direction of the torque applied to the track 16. The pressurized hydraulic fluid may travel through the motors 26 in one or more directions. The motors 26 are configured to receive the hydraulic fluid, sending the discharged hydraulic fluid to a hydraulic tank 28. The hydraulic fluid is then sent back to the pumps 24, forming a hydraulic circuit. Hydraulic circuits may be used to power one or more working implements within the mining vehicle 10, including the vehicle tracks 16.

Referring again to FIG. 2, the hydraulic system 20 is shown according to when the mining vehicle 10 is in the neutral position and the track 16 is not moving. In this mode, the control spool 46 is in a center position, receiving hydraulic fluid from the hydraulic pumps 24. Hydraulic fluid passes through the control spool 46 and back to the hydraulic tank 28 through fluid line 39. At the hydraulic tank 28, the hydraulic fluid may be cleaned, filtered, and de-aerated, then sent back to the hydraulic pumps 24 for re-use within the system 20.

In the illustrated embodiment of FIGS. 2 through 6, the system 20 includes a single hydraulic circuit powering the track 16 of the mining vehicle 10. In other embodiments, however, the system 20 may include two or more hydraulic circuits powering one or more working implements or other hydraulically-operated components of the vehicle 10. Pressurized hydraulic fluid travels through the system 20 in a clockwise or counterclockwise direction, supplying the motors 26. The motors 26 are configured to convert the pressure differential of the fluid into a torque. The motors 26 apply the torque to the tracks 16, causing the tracks 16 to move.

The direction of the torque applied to the track 16 corresponds to the pressure differential of the hydraulic fluid at the motors 26, and the magnitude of the torque applied is roughly proportional to the magnitude of the pressure differential. When the track 16 is moving forward, as shown in FIGS. 3 and 4, the fluid may travel through the system 20 in a counterclockwise direction, and through the motors 26 from left to right (according to the schematic representation of FIGS. 2 through 6). When the fluid is traveling counter-clockwise through the system 20, and the pressure of the fluid entering from the left side of the motor 26 is greater than the pressure of the fluid leaving from the right side of the motor 26 (as shown in FIG. 3), the motor 26 is configured to apply a torque to the track 16, moving the track 16 in a forward direction. When the fluid is traveling counter-clockwise through the system 20, and the pressure of the fluid entering from the left side of the motor 26 is less than the pressure of the fluid leaving from the right side of the motor 26 (as shown in FIG. 4), the motor 26 is configured to apply a braking torque to the track 16, braking the forward motion of the track 16.

When the mining vehicle 10 is traveling in reverse, as shown in FIGS. 5 and 6, the fluid may travel through the system 20 in a clockwise direction, and through the motors 26 from right to left (according to the schematic representation of FIGS. 2 through 6). When the fluid is traveling clockwise through the system 20, and the pressure of the fluid entering the right side of the motor 26 is greater than the pressure of the fluid leaving the left side of the motor 26 (as shown in FIG. 5), the motor 26 is configured to apply a torque to the track 16, moving the track 16 in a reverse direction. When the fluid is traveling clockwise through the system 20, and the pressure of the fluid entering the right side of the motor 26 is less than the pressure of the fluid leaving the left side of the motor 26 (as shown in FIG. 6), the motor 26 is configured to apply a braking torque to the track 16, braking the reverse motion of the track 16.

Referring still to FIGS. 2 through 6, the fluid line 23 or 21 (depending on the direction of the track 16) receives pressurized hydraulic fluid from the pumps 24, directing the hydraulic fluid through the rotor 22. The rotor 22 is connected to the upper carriage 14 and the lower carriage 12, and allows the upper carriage 14 to rotate independently of the lower carriage 12. The rotor 22 includes moving parts, and also includes small openings for the fluid lines 23 and 21 to pass through. Therefore, the fluid lines 23 and 21 may be restricted to some degree as they pass through the rotor 22, creating a pressure drop within the lines 23 and 21.

Once through the rotor 22, the hydraulic fluid enters the lower carriage 12. Referring now to FIGS. 3 and 4, a schematic representation for the hydraulic system 20 is shown, according to when the track 16 and vehicle 10 are moving forward. When the track 16 is moving in a forward direction, hydraulic fluid may travel through the system 20 in a counter-clockwise direction (according to the schematic representation of FIGS. 3 and 4). The hydraulic fluid continues from the rotor 22 through the fluid line 23, and flowing to the check valve 34. The check valve 34 is configured to remain closed until the hydraulic fluid in line 23 reaches a predetermined fluid pressure. In exemplary embodiments, the check valve 34 is configured to remain closed until the fluid pressure in fluid line 23 is at least 3 bar greater than the fluid pressure in downstream fluid line 25. With the check valve 34 closed, the fluid pressure in the fluid line 23 builds until it reaches the predetermined pressure. At that point, the check valve 34 is pushed open by the pressure of the hydraulic fluid, allowing hydraulic fluid to flow into the downstream fluid line 25. The pressurized fluid travels through the fluid line 25 to the hydraulic motors 26. The hydraulic fluid passes through the hydraulic motors 26, providing pressurized fluid to the motors 26. When fluid is traveling through the system 20 in a counter-clockwise direction, and when the pressure of the fluid entering the motors 26 is greater than the pressure of the fluid exiting the motors 26, such as in the illustrated embodiment of FIG. 3, the motors 26 are configured to apply a torque to the track 16, driving the track 16 and the vehicle 10 in a forward direction. In exemplary embodiments, the magnitude of the pressure differential at the motors 26 is roughly proportional to the magnitude of the torque that the motors 26 apply to the track 16.

Once the hydraulic fluid travels through the motors 26, it is recycled back through the system 20 and eventually to the pumps 24 via the hydraulic tank 28. When the track 16 is moving forward, the hydraulic fluid may be sent back through fluid line 27 and to a brake valve 44 (as shown in FIGS. 3 and 4). Pilot line pressure from the fluid line 23 pushes the brake valve 44 into a fluid alignment with the fluid line 21, opening the brake valve 44. The opened valve 44 allows hydraulic fluid to travel from the fluid line 27 through the brake valve 44, and back to the hydraulic tank 28. The brake valve 44 remains open when there is high pressure hydraulic fluid traveling in a counter-clockwise direction through fluid line 23. When hydraulic fluid travels in a counter-clockwise direction through the system 20 (as in FIGS. 3 and 4), the mining vehicle 10 may be traveling in a forward direction. However, when the fluid pressure in fluid line 25 is less than the fluid pressure in fluid line 27 (as in FIG. 4), the brake valve 44 moves out of direct alignment with fluid line 27 and partially closes, creating high pressure upstream of the brake valve 44. The negative pressure differential at the motors 26 causes the motors 26 to apply a torque to the track 16 in the reverse direction. The torque applied in the reverse direction creates a braking torque on the track 16, braking the forward motion of the track 16, and braking the forward motion of the mining vehicle 10.

Referring now to FIGS. 5 and 6, a schematic representation for the hydraulic system 20 is shown, according to when the track 16 and the vehicle 10 are moving in reverse. When the track 16 is moving in a reverse direction, hydraulic fluid may move through the system 20 in a clockwise direction (according to the schematic representation of FIGS. 5 and 6). The hydraulic fluid continues from the rotor 22 through the fluid line 21, flowing to the check valve 32. The check valve 32 is configured to remain closed until the fluid in line 21 reaches a predetermined fluid pressure. In exemplary embodiments, the check valve 32 is configured to remain closed until the fluid pressure in fluid line 21 is at least 3 bar greater than the fluid pressure in downstream fluid line 27. With the check valve 32 closed, the fluid pressure in the fluid line 21 builds until it reaches the predetermined pressure. At that point, the check valve 32 is pushed open by the pressure of the hydraulic fluid, allowing hydraulic fluid to flow into the downstream fluid line 27. The pressurized fluid travels through the fluid line 27 to the hydraulic motors 26. The hydraulic fluid passes through the hydraulic motors 26, providing pressurized fluid to the motors 26. When fluid is traveling through the system 20 in a clockwise direction, and when the pressure of the fluid entering the motors 26 is greater than the pressure of the fluid exiting the motors 26, such as in the illustrated embodiment of FIG. 5, the motors 26 are configured to apply a torque to the track 16, driving the track 16 and the vehicle 10 in a reverse direction. In exemplary embodiments, the magnitude of the pressure differential at the motors 26 is directly proportional to the magnitude of the torque that the motors 26 apply to the track 16.

Once the hydraulic fluid travels through the motors 26, it is recycled back through the system 20 to the pumps 24 via the hydraulic tank 28. When the track 16 is traveling in reverse, the hydraulic fluid may be sent back through fluid line 25 and to a brake valve 42 (as shown in FIGS. 5 and 6). Pilot line pressure from the fluid line 21 pushes the brake valve 42 into a fluid alignment with the fluid line 23, opening the brake valve 42. The opened valve 42 allows hydraulic fluid to travel from the fluid line 25 through the brake valve 42, and back to the hydraulic tank 28. The brake valve 42 remains open when there is high pressure hydraulic fluid traveling in a clockwise direction through fluid line 21. When hydraulic fluid travels in a clockwise direction through the system 20 (as in FIGS. 5 and 6), the mining vehicle 10 may be traveling in a reverse direction. However, when the fluid pressure in fluid line 27 is less than the fluid pressure in fluid line 25 (as in FIG. 6), the brake valve 42 moves out of direct alignment with fluid line 25 and partially closes, creating high pressure upstream of the brake valve 42. The negative pressure differential at the motors 26 causes the motors 26 to apply a torque to the track 16 in a forward direction. The torque applied in the forward direction creates a reverse braking torque on the track 16, braking the reverse motion of the track 16, and braking the reverse motion of the mining vehicle 10.

Once the hydraulic fluid flows back through the brake valve 44 or 42, the hydraulic fluid travels through the fluid line 21 or 23, and back through the rotor 22. From the rotor 22, the hydraulic fluid travels to the upper carriage 14 through fluid line 21 or 23. The hydraulic fluid may enter the control spool 46, and is routed through fluid line 39 into the hydraulic tank 28. The hydraulic fluid may be filtered, cooled, and de-aerated in the hydraulic tank 28, and is then sent back to the hydraulic pumps 24 for re-use within the system 20.

Referring again to FIGS. 2 through 6, the hydraulic system 20 includes two pilot-operated makeup valves 30 and 40, according to exemplary embodiments. However, in other exemplary embodiments, the hydraulic system 20 may include more or less pilot-operated makeup valves 30 or 40, depending on what is necessary for the particular application. For instance, in an embodiment where the hydraulic fluid flows in a single direction throughout the hydraulic system 20, a single pilot-operated makeup valve 30 or 40 may be sufficient.

The pilot-operated makeup valve 40 moves between a non-actuated position and an actuated position. In the non-actuated position (shown in FIGS. 5 and 6), the valve 40 is not fluidly connected to either fluid line 23 or 21, blocking hydraulic fluid from traveling between the two lines 23 and 21. In the actuated position (shown in FIGS. 3 and 4), the valve 40 is fluidly connected to the fluid lines 23 and 21. In the actuated position, the valve 40 is configured to allow hydraulic fluid to travel through the valve 40 in a single direction, from the fluid line 21 to the fluid line 23.

Referring again to FIGS. 3 and 4, the pilot-operated makeup valve 40 may move into the actuated position when predetermined conditions are present within the system 20. According to FIGS. 3 and 4, the pilot-operated makeup valve 40 is connected to fluid lines 25 and 23 by pilot lines 33 and 31, respectively. The pilot lines 33 and 31 are passages that transmit the fluid pressure of lines 25 and 23, respectively, to the pilot-operated makeup valve 40. The pilot-operated check valve 40 may move into the actuated position (shown in FIGS. 3 and 4) when the fluid pressure in lines 25 and 23 reaches a first predetermined pressure differential. The first predetermined pressure differential may be any predetermined difference in fluid pressure that exists between the fluid lines 23 and 25. In exemplary embodiments, the pilot-operated makeup valve 40 is moved from the non-actuated position to the actuated position when the pressure in line 23 is at least 3 bar greater than the pressure in line 25. These particular pressure conditions may occur when the track 16 and mining vehicle 10 are moving in a forward direction, and the pressurized hydraulic fluid is traveling through the system 20 in a counter-clockwise direction, such as in the illustrated embodiment of FIG. 3. In other embodiments, the pilot-operated makeup valve 40 may be configured to move into the actuated position in response to any other appropriate conditions present within the system 20.

Once the pilot-operated makeup valve 40 is in the actuated position, the valve 40 acts as a one-way check valve, remaining closed until further specific conditions are present within the system 20, such as a second predetermined pressure differential. In exemplary embodiments, the makeup valve 40 is configured to open when the fluid pressure in the fluid line 23 is lower than the fluid pressure in the fluid line 21. This pressure condition may occur when the mining vehicle 10 is braking or slowing down, and is shown in FIG. 4. For instance, when the mining vehicle 10 is braking or slowing down, the control spool 46 may be shifted to some extent, diverting hydraulic fluid away from the fluid line 23 and away from the inlet of the motors 26. The fluid pressure in fluid line 23 will fall, causing the brake valve 44 to partially close, and providing braking torque for the motors 26. When the braking torque is applied to the track 16, the vehicle 10 does not immediately stop because of inertia. The motors 26 may then continue to draw hydraulic fluid from the fluid line 23 as the fluid line 23 receives less hydraulic fluid from the pumps 24. It is during such an event that the hydraulic fluid pressure at the pump side of the motors 26 may drop down to zero, thus creating a condition where the motor inlet is likely to be voided. Under these pressure conditions, the pilot-operated makeup valve 40 acts as a one-way valve, allowing hydraulic fluid to travel from the fluid line 21 to the fluid line 23, rather than back to the hydraulic tank 28, in order to prevent a voiding condition at the inlets of the motors 26. The pilot-operated makeup valve 40 may also be configured to divert hydraulic fluid to the motor inlet under any other conditions present within the system 20, in other exemplary embodiments. In the illustrated embodiments, the pilot-operated makeup valve 40 is configured to remain open until the pressure in the fluid line 23 is at least equal to the pressure in the fluid line 21. However, the pilot-operated makeup valve 40 may be configured to open or close based on any other conditions within the system 20, depending on the particular application.

The pilot-operated makeup valve 30 moves between a non-actuated position and an actuated position. In the non-actuated position (shown in FIGS. 3 and 4), the valve 30 is not fluidly connected to either fluid line 23 or 21, blocking hydraulic fluid from traveling between the two lines 23 and 21. In the actuated position (shown in FIGS. 5 and 6), the valve 30 is fluidly connected to the fluid lines 23 and 21. In the actuated position, the valve 30 is configured to allow hydraulic fluid to travel through the valve 30 in a single direction, from the fluid line 23 to the fluid line 21.

Referring again to FIGS. 5 and 6, the pilot-operated makeup valve 30 may move into the actuated position when predetermined conditions are present within the system 20. According to FIGS. 5 and 6, the pilot-operated makeup valve 30 is connected to fluid lines 27 and 21 by pilot lines 35 and 37, respectively. The pilot lines 35 and 37 are passages that transmit the fluid pressure of lines 27 and 21, respectively, to the pilot-operated makeup valve 30. The pilot-operated check valve 30 may move into the actuated position when the fluid pressure in lines 27 and 21 reaches a first predetermined pressure differential. The first predetermined pressure differential may be any predetermined difference in fluid pressure that exists between the fluid lines 27 and 21. In exemplary embodiments, the pilot-operated makeup valve 30 is moved from the non-actuated position to the actuated position when the pressure in line 21 is at least 3 bar greater than the pressure in line 27. These particular pressure conditions may occur when the track 16 and mining vehicle 10 are moving in a reverse direction, and the pressurized hydraulic fluid is traveling through the system 20 in a clockwise direction, such as in the illustrated embodiment of FIG. 5. In other embodiments, the pilot-operated makeup valve 30 may be configured to move into the actuated position in response to any other appropriate conditions present within the system 20.

Once the pilot-operated makeup valve 30 is in the actuated position, the valve 30 acts as a one-way check valve, remaining closed until further specific conditions are present within the system 20, such as the second predetermined pressure differential. In exemplary embodiments, the makeup valve 30 is configured to open when the fluid pressure in the fluid line 21 is lower than the fluid pressure in the fluid line 23. This pressure condition may occur when the mining vehicle 10 is braking or slowing down when traveling in reverse, and is shown in FIG. 6. For instance, when the mining vehicle 10 is braking or slowing down, the control spool 46 may be shifted to some extent, diverting hydraulic fluid away from the fluid line 21 and away from the inlet of the motors 26. The fluid pressure in fluid line 21 will fall, causing the brake valve 42 to partially close, and providing braking torque for the motors 26. When the braking torque is applied to the track 16, the vehicle 10 does not immediately stop because of inertia. The motors 26 may then continue to draw hydraulic fluid from the fluid line 21 as the fluid line 21 receives less hydraulic fluid from the pumps 24. It is during such an event that the hydraulic fluid pressure at the pump side of the motors 26 may drop down to zero, thus creating a condition where the motor 26 inlet is likely to be voided. Under these pressure conditions, the pilot-operated makeup valve 30 acts as a one-way valve, allowing hydraulic fluid to travel from the fluid line 23 to the fluid line 21, rather than back to the hydraulic tank 28, in order to prevent a voiding condition at the inlets of the motors 26. The pilot-operated makeup valve 30 may also be configured to divert hydraulic fluid to the motor 26 inlet under any other conditions present within the system 20, in other exemplary embodiments. In the illustrated embodiments, the pilot-operated makeup valve 30 is configured to remain open until the pressure in the fluid line 21 is at least equal to the pressure in the fluid line 23. However, the pilot-operated makeup valve 30 may be configured to open or close based on any other conditions within the system 20, depending on the particular application.

Referring again to FIGS. 2 through 6, the hydraulic system 20 may include a back pressure relief 38 and one or more makeup valves 36. In exemplary embodiments, the back pressure relief 38 and makeup valves 36 provide back pressure (i.e. pressurized hydraulic fluid sent back through the return line to the motors 26) to one or more motors 26 to prevent those motors 26 from voiding. The hydraulic system 20 may contain more than one circuit for operating other working implements (e.g. shovels, dippers, etc.). The back pressure relief 38 may provide hydraulic fluid to the system 20, so that the motors 26 within these circuits are not voided, keeping the hydraulic circuits operational. In addition, the hydraulic system 20 may occasionally lose hydraulic fluid during operation, and the back pressure relief 38 may be used to replace the hydraulic fluid.

The back pressure relief 38 is fluidly connected to the makeup valves 36, and sends pressurized hydraulic fluid to the makeup valves 36. The makeup valves 36 are fluidly connected to the fluid lines 21 and 23. The back pressure relief 38 pumps hydraulic fluid to the makeup valves 36. In exemplary embodiments, the makeup valves 36 are check valves opening when the pressure at the valves 36 reaches a third predetermined pressure, sending hydraulic fluid to the system 20. In exemplary embodiments, the back pressure relief 38 provides hydraulic fluid at a pressure of approximately 5-6 bar. However, in other embodiments, the back pressure relief 38 may provide hydraulic fluid at a higher or lower pressure, depending on what is necessary for the particular application.

The construction and arrangements of the hydraulic system 20, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

### INDUSTRIAL APPLICABILITY

The disclosed hydraulic system may be implemented into any hydraulic machine, particularly machines having long fluid lines or having pressure-reducing features, such as restrictive fluid passages. The disclosed hydraulic system may reduce the amount of back pressure necessary to prevent voiding the hydraulic motors by diverting hydraulic fluid from the return lines to provide the motors with pressurized hydraulic fluid. By reducing the back pressure applied, the disclosed hydraulic system requires less energy. Therefore, the disclosed hydraulic system may increase the efficiency of the hydraulic machine.

It will be apparent to those skilled in the art that various modifications and variations can be made to the disclosed hydraulic system. Other embodiments will be apparent to those skilled in the art from consideration of the specification and practice of the disclosed hydraulic system. It is intended that the specification and examples be considered as exemplary only, with a true scope being indicated by the following claims and their equivalents.

What is claimed is:

1. A hydraulic system for a hydraulic vehicle, comprising:
one or more hydraulic pumps configured to pump pressurized fluid through the hydraulic system;
one or more hydraulic motors configured to receive pressurized fluid, and to power one or more working implements;
a hydraulic tank configured to receive return fluid flow from the hydraulic motors and supply the fluid to the hydraulic pumps;
one or more fluid lines configured to transfer fluid throughout the hydraulic system;
one or more check valves fluidly connected to the hydraulic pumps and fluidly connected to the hydraulic motors, the check valves configured to receive fluid from the hydraulic pumps at a first end, and to supply fluid to the hydraulic motors at a second end, and configured to move from a closed position to an open position when the fluid pressure at the first and second ends reaches a first predetermined pressure differential, allowing fluid to travel from the hydraulic pumps to the hydraulic motors;
one or more pilot-operated valves, operably coupled to the check valves by one or more pilot lines, and configured to move from a first position to a second position when the fluid pressure at the check valves reaches the first predetermined pressure differential, the second position fluidly connecting the pilot-operated valves to the fluid lines; and
wherein the pilot-operated valves are configured to receive fluid pressure from a first fluid line and a second fluid line, opening and allowing fluid to travel in a single direction between the first and second fluid lines when the pressure in the first and second fluid lines reaches a second predetermined pressure differential.

2. The hydraulic system of claim 1, wherein the first and second fluid lines are configured to act as return lines that receive fluid from one or more hydraulic motor outlets, and are also configured to act as supply lines that send fluid to one or more hydraulic motor inlets.

3. The hydraulic system of claim 2, wherein the first fluid line is a supply line and the second fluid is a return line when the hydraulic system is in a first mode, and the second fluid line is a supply line and the first fluid line is a return line when the hydraulic system is in a second mode.

4. The hydraulic system of claim 3, wherein the second predetermined pressure differential is achieved when the fluid pressure in the return line is greater than the fluid pressure in the supply line.

5. The hydraulic system of claim 2, further comprising a control spool configured to receive pressurized fluid from the hydraulic pumps, wherein the control spool is configured to pump pressurized fluid in a first direction when the hydraulic system is in a first mode, and to pump pressurized fluid in a second direction when the hydraulic system is in a second mode.

6. The hydraulic system of claim 1, wherein the check valves are configured to open from the force of the pressurized fluid when the fluid pressure at the check valves reaches the first predetermined pressure differential.

7. The hydraulic system of claim 6, wherein the first predetermined pressure differential occurs when the fluid pressure from the hydraulic pumps to the check valves is 3 bar greater than the fluid pressure from the check valves to the hydraulic motors.

8. The hydraulic system of claim 1, further comprising:
one or more back pressure relief sources configured to supply pressurized fluid;
one or more makeup valves configured to receive pressurized fluid from the back pressure relief sources and provide the fluid to the hydraulic system when predetermined conditions are present.

9. The hydraulic system of claim 1, wherein at least one working implement is vehicle tracks configured to move the hydraulic vehicle in more than one direction.

10. The hydraulic system of claim 1, further comprising brake valves fluidly connected to the fluid lines, and configured to provide braking torque for stopping the hydraulic vehicle.

11. A hydraulic vehicle, comprising:
one or more fluid lines configured to transfer fluid throughout the vehicle;
an upper carriage configured to rotate independently of a lower carriage, comprising:
one or more hydraulic pumps configured to pump pressurized fluid to the fluid lines;
a hydraulic tank configured to receive return fluid flow from one or more hydraulic motors and supply the fluid to the hydraulic pumps;
a lower carriage, comprising:
one or more hydraulic motors configured to receive pressurized fluid, and to power one or more working implements;
one or more check valves fluidly connected to the hydraulic pumps and fluidly connected to the hydraulic motors, the check valves configured to receive fluid from the hydraulic pumps at a first end, and to supply fluid to the hydraulic motors at a second end, and configured to move from a closed position to an open position when the fluid pressure at the first and second ends reaches a first predetermined pressure differential, allowing fluid to travel from the hydraulic pumps to the hydraulic motors;
one or more pilot-operated valves, operably coupled to the check valves by one or more pilot lines, and configured to move from a first position to a second position when the fluid pressure at the check valves reaches the first predetermined pressure differential, the second position fluidly connecting the pilot-operated valves to the fluid lines; and
a rotor connected on a first end to the upper carriage, and connected on a second end to the lower carriage; and
wherein the pilot-operated valves are configured to detect the fluid pressure in a first fluid line and a second fluid line, opening and allowing fluid to travel in a single direction between the first and second fluid lines when the pressure in the first and second fluid lines reaches a second predetermined pressure differential.

12. The hydraulic vehicle of claim 11, wherein the first and second fluid lines are configured to act as return lines that receive fluid from one or more hydraulic motor outlets, and are also configured to act as supply lines that send fluid to one or more hydraulic motor inlets.

13. The hydraulic vehicle of claim 12, wherein the first fluid line is a supply line and the second fluid is a return line when the vehicle is moving forward, and the second fluid line is a supply line and the first fluid line is a return line when the vehicle is moving in reverse or stopped.

14. The hydraulic vehicle of claim 13, wherein the second predetermined pressure differential is achieved when the fluid pressure in the return line is greater than the fluid pressure in the supply line.

15. The hydraulic vehicle of claim 1, wherein the check valves are configured to open from the force of the pressurized fluid when the fluid pressure at the check valves reaches the first predetermined pressure differential.

16. The hydraulic vehicle of claim 15, wherein the first predetermined pressure differential occurs when the fluid pressure from the hydraulic pumps to the check valves is 3 bar greater than the fluid pressure from the check valves to the hydraulic motors.

17. A method for powering a hydraulic vehicle, the method comprising:
supplying one or more hydraulic motors with fluid from one or more hydraulic pumps;
returning the fluid from the hydraulic motors to the hydraulic pumps;
transmitting the fluid pressure within the system to one or more pilot-operated check valves;
providing one or more check valves moving from a closed position to an open position when the fluid pressure reaches a first predetermined pressure differential, allowing fluid to travel from the hydraulic pumps to the hydraulic motors;
providing one or more pilot-operated valves moving from a first position to a second position when the fluid pressure at the check valves reaches the first predetermined pressure differential, the second position fluidly connecting the pilot-operated valves to the fluid lines; and
preventing the hydraulic motors from voiding by supplying fluid in a single direction between the first and second fluid lines when the pressure in the first and second fluid lines reaches a second predetermined pressure differential.

18. The method of claim 17, wherein the second predetermined pressure differential is achieved when the fluid pressure in a hydraulic motor return line is greater than the fluid pressure in a hydraulic motor supply line.

19. The method of claim 17, wherein the check valves push open from the force of the pressurized fluid when the fluid pressure at the check valves reaches the first predetermined pressure differential.

20. The method of claim 19, wherein the first predetermined pressure differential occurs when the fluid pressure from the hydraulic pumps to the check valves is 3 bar greater than the fluid pressure from the check valves to the hydraulic motors.
